(19) United States
(12) Patent Application Publication
(10) Pub. No.: US 2012/0073182 A1
(43) Pub. Date: Mar. 29, 2012

(54) MULTI ARM FISHING RIG WITH FLEXIBLE ARMS

(76) Inventor: Michael A. Poss, Muscle Shoals, AL (US)

(21) Appl. No.: 13/030,014

(22) Filed: Feb. 17, 2011

(51) Int. Cl. A01K 85/00

(52) U.S. Cl. 43/42.13; 43/42.26

(57) ABSTRACT

A multi-arm fishing rig with flexible arms has been developed. The fishing rig includes a head that connects to a fishing line and multiple arms that connect to the head. The arms are suitable for attaching bait to each individual arm. The arms are also made of a flexible material that allows each arm to be adjusted in a position relative to the other arms and to retain the position while in use.

### FIELD OF THE INVENTION

The invention relates generally to fishing equipment. More specifically, the present invention relates to a multi-arm fishing rig with flexible arms.

### BACKGROUND ART

A fishing “rig” is an arrangement of items used for attracting and hooking fish. It can be assembled of one or more lines, hooks, sinkers, bobbers, swivels, lures, beads, and other fishing tackle. “Trolling” is a method of fishing where one or more fishing lines, baited with lures or bait fish, are drawn through the water. This is typically behind a moving boat where the rig is baited and then dipped in the water behind the boat.

While multi-arm rigs are known, they have been used exclusively for trolling. A typical trolling rig has multiple rigid arms that extend out perpendicularly from a center point. The rigidity of the extended arms makes the rig impractical to cast. Consequently, a multi-arm fishing rig that is suitable for casting is needed.

### SUMMARY OF THE INVENTION

In some aspects, the invention relates to a fishing rig, comprising: a head that connects to a fishing line; multiple arms that connect to the head, where the arms are suitable for attaching a bait for each individual arm; and where the arms are made of a flexible material that allows each arm to be adjusted in a position relative to the other arms and to retain the position while in use.

In other aspects, the invention relates to a fishing rig, comprising: a head that connects to a fishing line; and a flexible means for connecting multiple baits to the head.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a side view of one embodiment of the present invention.

FIG. 2 shows an overhead view of embodiment of the present invention.

FIG. 3 shows an frontal view of embodiment of the present invention.

### DETAILED DESCRIPTION

A multi-arm fishing rig with flexible arms has been developed. The rig has multiple flexible arms that extend outward. Since the arms are flexible, they may be adjusted to different positions to allow the rig to be easily cast and retrieved repeatedly by the fisherman.

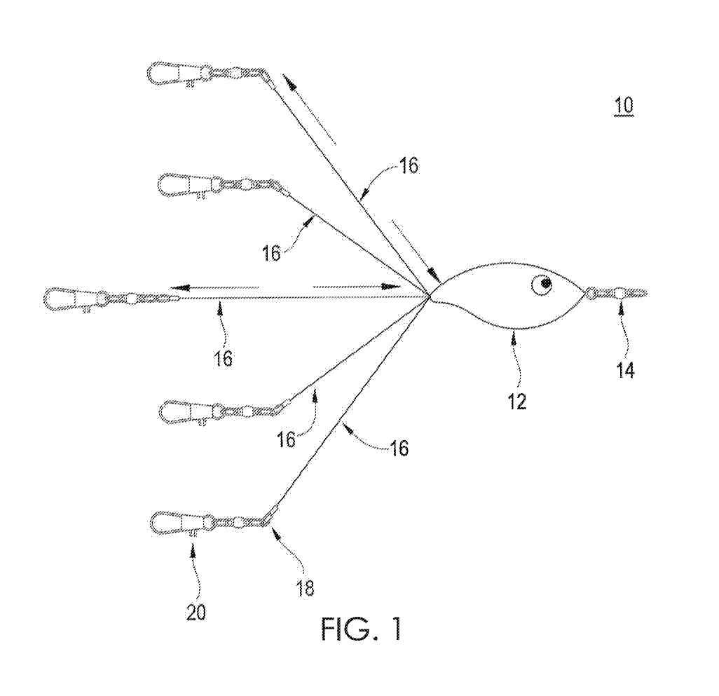

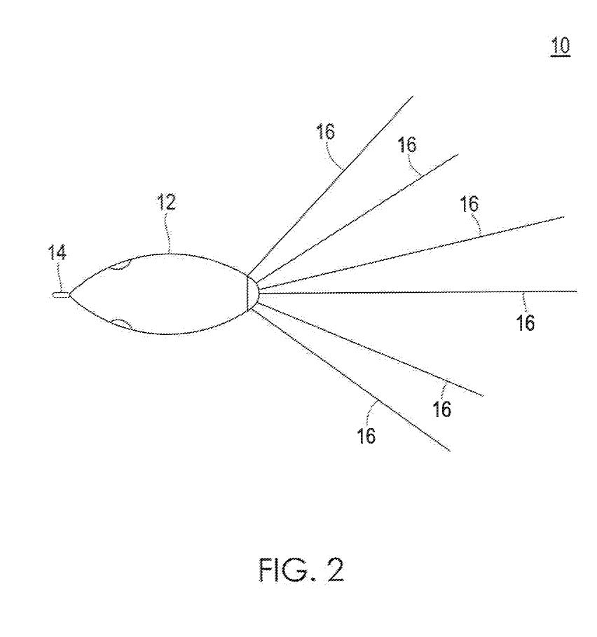

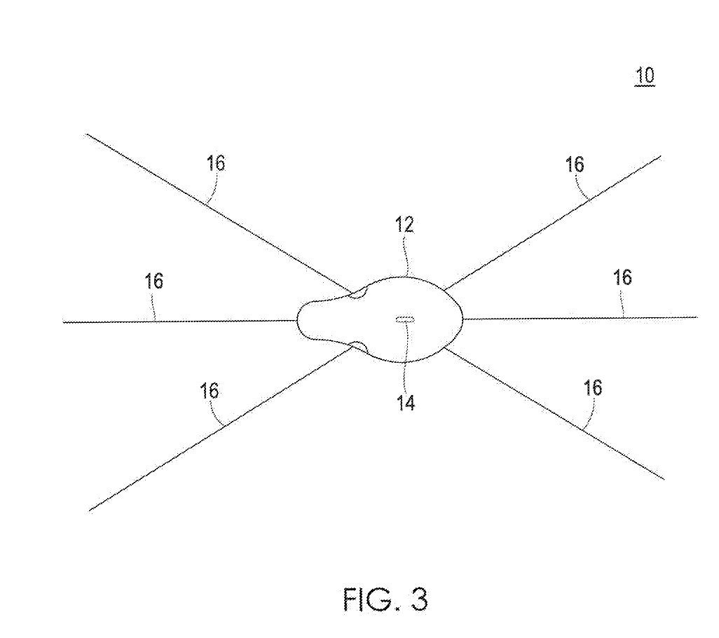

FIG. 1 shows one example of the present invention. FIG. 2 shows an overhead view while FIG. 3 shows a frontal view of the invention. The rig 10 includes a head 12 that acts as the central connection point for the arms 16. The front of the head 12 has as line swivel 14 that attaches the rig 10 to a line leader (not shown) for the fisherman's rod. The swivel 14 may be a standard type of barrel fishing swivel that is well known in the art. It may be of various sizes and may use a standard locking mechanism for ease of use.

The head 12 may be made of various types of materials such as lead, plastic, balsa wood, etc. The type of material selected may be based on the rate at which the rig is desired to sink. For example, in order to fish at a deeper depth, lead may be selected for a head. The size of the head may vary as well. Additionally, the head 12 may be decorated with paint and/or designs to simulate bait that is attractive to fish. In other embodiments, the head may be detachable so that it can be replaced with a head of a different weight or color.

On the rear of the head 12, multiple flexible arms 16 extend outward from a central point. In this example, five separate arms 16 are shown with one arm in the center of the array while the other arms extend out around it similar to an umbrella. However, the number, length and thickness of the arms may vary with different embodiments of the present invention. In the example shown, the arms 16 extend through the interior of the head 12 and are connected to the line swivel 14. The body of the head 12 is cast around the arms 16. In other embodiments of the present invention, the arms could be connected to an interior mount inside the body of the head 12. Alternatively, the arms could be connected to an attachment on the rear of the body of the head 12.

It is key to note that the arms are made of a flexible material. This allows the arms to be bent to various positions in order to allow for repeated casting by the fisherman. In some embodiments, the arms may be made of the flexible wire with a gauge thickness from 0.30-0.51. The wire may be a metal such as stainless steel or a plastic or a combination of metal and plastic. The key feature is that the material is flexible enough to be bent and rigid enough to hold its position once it is bent. Additionally, an arm is flexible along its entire length so that it can be bent at any point or at multiple points along its length.

In the example shown, each arm 16 has an eyelet 18 on the end opposite the head 12. The eyelet 18 is permanently attached to the arm 16. As with the front of the head 12, a swivel 20 is connected to the eyelet 18. As before, the swivel 20 may be a standard type of barrel fishing swivel that is well known in the art. It may be of various sizes and may use a standard locking mechanism for ease of use. The baits are connected to the swivel 20. The baits may vary widely in type, shape, size, color and weight based on the desires of the fisherman. The advantage of the present invention includes being able to adjust the positioning of the arms to allow for easy transport and easy repetitive casting. This allows a fisherman to simulate a school a bait fish and present the baits in a manner that is attractive to fish.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A fishing rig, comprising:
a head that connects to a fishing line;
multiple arms that connect to the head, where the arms are suitable for attaching a bait for each individual arm; and
where the arms are made of a flexible material that allows each arm to be adjusted in a position relative to the other arms and to retain the position while in use.

2. The fishing rig of claim 1, where the arms extend through the interior of the head.

3. The fishing rig of claim 1, where the head comprises lead.

4. The fishing rig of claim 1, where the head connects to the fishing line with a swivel.

5. The fishing rig of claim 1, where each arm is attached to the bait with swivel.

6. The fishing rig of claim 1, where the flexible material comprises a flexible metal wire.

7. The fishing rig of claim 6, where the flexible metal wire has a thickness between 0.030-0.051 gauge.

8. A fishing rig, comprising:
a head that connects to a fishing line; and
a flexible means for connecting multiple baits to the head.
